(19) United States
(12) Patent Application Publication
(10) Pub. No.: US 2023/0419327 A1
(43) Pub. Date: Dec. 28, 2023

(54) SECURE AND SCALABLE BLOCKCHAIN SMART CONTRACT-BASED DIGITAL ASSET PLATFORM

(71) Applicant: AnChain.ai, Inc., San Jose, CA (US)

(72) Inventors: Ben Binyi Wu, San Jose, CA (US); Francesco Piccoli, San Jose, CA (US); Chunsheng Victor Fang, San Jose, CA (US); Christopher De Leon, San Jose, CA (US)

(73) Assignee: AnChain.ai, Inc., San Jose, CA (US)

(21) Appl. No.: 18/309,350

(22) Filed: Apr. 28, 2023

Related U.S. Application Data
(60) Provisional application No. 63/354,578, filed on Jun. 22, 2022.

(51) Int. Cl. G06Q 20/40; G06Q 20/38

(52) U.S. Cl. CPC G06Q 20/4016; G06Q 20/389; G06Q 20/3829

(57) ABSTRACT

A computing apparatus, a non-transitory computer-readable storage medium, and a method of offering blockchain transactions of non-fungible tokens (NFTs) including providing a digital storefront platform for the NFTs with a mint module, configured to create and mint NFTs on blockchains, and a trade module configured to transact with the minted NFTs. A key cycler is configured to allow parallel transactions with blockchains, payment processors, the mint module, and the trade module. The key cycler includes a plurality of private keys on a web-based key management service (KMS). The key cycler is configured to facilitate transaction payments using fiat currency or cryptocurrency. Anti-money laundering (AML) and counter-terrorism financing (CTF) screening capabilities may be incorporated into the disclosed solution.

This application claims the benefit of U.S. provisional patent application Ser. No. 63/354,578, filed on Jun. 22, 2022, the contents of which are incorporated herein by reference in their entirety.

### BACKGROUND

Non-fungible tokens (NFTs) are units of data stored on a blockchain. They are uniquely identifiable and tradeable, but not interchangeable among each other. As more and more individuals and companies need to protect and verify ownership of their digital assets, such as NFTs, interaction with the blockchain is one of the main challenges. It requires deep expertise in blockchain development, smart contracts, anti-money laundering (AML), and counter-terrorism financing (CTF) practices, which most people do not have, given the short and fast-paced history of blockchain technology.

Conventional methods involve either building an entire end-to-end infrastructure from scratch to connect to the blockchain, or using interfaces of highly centralized marketplaces that have little room for customization. Solutions on the market usually include a single component needed for an end-to-end solution, but not the various components combined. None of these solutions traditionally come with AML/CTF screening capabilities integrated into the design. Such components may be available through purchase of expensive licenses, but are often provided by vendors that are not experienced in handling NFTs. Conventional solutions also lack Software Development Kits (SDKs) that can be used for integration into existing systems, such as plugins for existing e-commerce websites and plugins and application programming interfaces (APIs) for game developers to integrate with their infrastructure.

There is a need, therefore, for a solution that supports tokenizing and commercializing digital assets in a simple, secure, and compliant manner, with the capability to integrate with existing systems, sites, and infrastructure.

### BRIEF SUMMARY

In one aspect, a method of offering blockchain transactions of non-fungible tokens (NFTs) is disclosed. The method includes providing a digital storefront platform for the NFTs, where the NFTs include smart contract-based digital assets. The digital storefront platform includes a mint module configured to create and mint NFTs on blockchains, a trade module configured to transact with the minted NFTs, a key cycler configured to allow parallel transactions with blockchains, payment processors, the mint module, and the trade module. The key cycler includes a key cycler controller for executing actions within the key cycler and facilitating the parallel transactions including at least one of the blockchains, the payment processors, the mint module, and the trade module. The key cycler further includes a plurality of private keys on a web-based key management service (KMS), indices of the plurality of private keys, a database including the indices and a status of each private key of the plurality of private keys, where the status includes available or unavailable. The method also includes receiving a request from a user to create and mint at least one new NFT on a blockchain, using the mint module. The method also includes creating and minting the at least one new NFT. The method also includes listing for sale, using the trade module, the minted at least one new NFT on the digital storefront platform. The method also includes transacting between a buyer and a seller, with the minted at least one new NFTs including performing the parallel transaction, the transacting including receiving a transaction request signal from the buyer or the seller. The method also includes the key cycler sending an available key query signal, by the key cycler controller to the database, to identify at least one private key with the status of available. The method also includes, on condition there are no private keys with the status of available, waiting until at least one private key has the status of available, on a web based key management service. The method further includes using the key cycler and the available more than one private keys to simultaneously process a currency transfer from the buyer for the NFT with a payment processor, and a transfer of ownership, from the seller, of the NFT on the blockchain.

Also disclosed herein is a computing apparatus comprising a processor and a memory storing instructions that, when executed by the processor, configure the apparatus to perform the method above.

Finally, disclosed herein is a non-transitory computer-readable storage medium, the computer-readable storage medium including instructions that when executed by a computer, cause the computer to perform the afore-disclosed method.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates SCDAP technical infrastructure 100 in accordance with one embodiment.

FIG. 2 illustrates a key cycler 200 in accordance with one embodiment.

FIG. 3 illustrates a system 300 for an AML module in accordance with one embodiment.

FIG. 4 illustrates a process 400 for an AML module in accordance with one embodiment.

FIG. 5 illustrates an interface for creating and minting an NFT with the mint module 500 in accordance with one embodiment.

FIG. 6 illustrates an interface for listing minted NFTs for trade with the trade module 600 in accordance with one embodiment.

FIG. 7 illustrates an interface for listing minted NFTs for trade with the trade module 700 in accordance with one embodiment.

FIG. 8 illustrates a digital storefront platform interface 800 in accordance with one embodiment.

FIG. 9 is an example block diagram of a computing device 900 that may incorporate embodiments of the present invention.

FIG. 10 illustrates a simplified system 1000 in which a server 1004 and a client device 1006 are communicatively coupled via a network 1002.

FIG. 11 illustrates a Cloud computing node 1100 in accordance with one embodiment.

FIG. 12 illustrates a Cloud computing system 1200 in accordance with one embodiment.

FIG. 13 illustrates Cloud computing functional abstraction layers 1300 in accordance with one embodiment.

### DETAILED DESCRIPTION

The disclosed solution allows users to securely create, mint, transfer, buy, and sell blockchain smart contract based digital assets such as NFTs. The smart contract-based digital asset platform (SCDAP) may include a combination of components interacting with each other to provide security through private keys storage, AML and CTF regulatory compliance, and scalability through a cloud-based, high throughput API. The SCDAP may allow users to tokenize and commercialize their digital assets through a few clicks on a web-based dashboard, in a secure and regulatory-compliant manner.

The disclosed solution, including the key cycler, may be completely blockchain agnostic, allowing assets to be minted across different block chains, such as Ethereum, Solana, Flow, Avalanche, Polygon and more. The solution may also be Web2.0 and Web3.0 friendly, allowing assets to be purchased using fiat currencies and cryptocurrencies. Web 2.0 refers to the World Wide Web (WWW) as it exists at this time. Web 3.0 is used to refer to a future phase of the WWW that as yet has no standard definition, but may be more open, more decentralized, and focus on greater user utility than the current WWW iteration. The disclosed solution may thus allow more experienced developers to integrate a blockchain component into their own applications using a few API calls. For example, this disclosure may support NFT smart contracts built on top of multiple blockchains.

The disclosed solution may be further utilized to tokenize physical world assets and create a digital twin of them. For example, a physical object may be digitally scanned to create a virtual three-dimensional replica. This data may be minted as an NFT. In one embodiment, quick response (QR) codes, other near-field communication (NFC), and other entities that will be well understood by one skilled in the art, may be used to map between the physical, real-world asset and the digital twin NFT representing that asset.

Key components of the disclosed solution may include a mint module, a trade module, a key cycler, and an AML module. The mint module may allow users to create and mint NFTs. Minting is the process of creating a new crypto asset and recording that information into a block that becomes part of a blockchain. The trade module may allow users to showcase, buy, transfer, and sell their minted NFTs. The key cycler may support parallel transactions to take place, representing a significant improvement in data flow. The AML module may maintain AML and CTF regulatory compliance throughout operation of the solution.

The disclosed solution may be used by game developers to tokenize in-game assets owned by players, such as skins, accessories, and clothing, on a blockchain. Artists may use this solution in tokenizing their digital artwork. Decentralized autonomous organizations (DAOs) may verify ownership of their tokenized membership cards. Digital collections of various types may be minted on the blockchain.

In one embodiment, gamification features may be built into the smart contract that powers the mint and trade modules. Different technologies may be used to store NFT metadata and NFT content files.

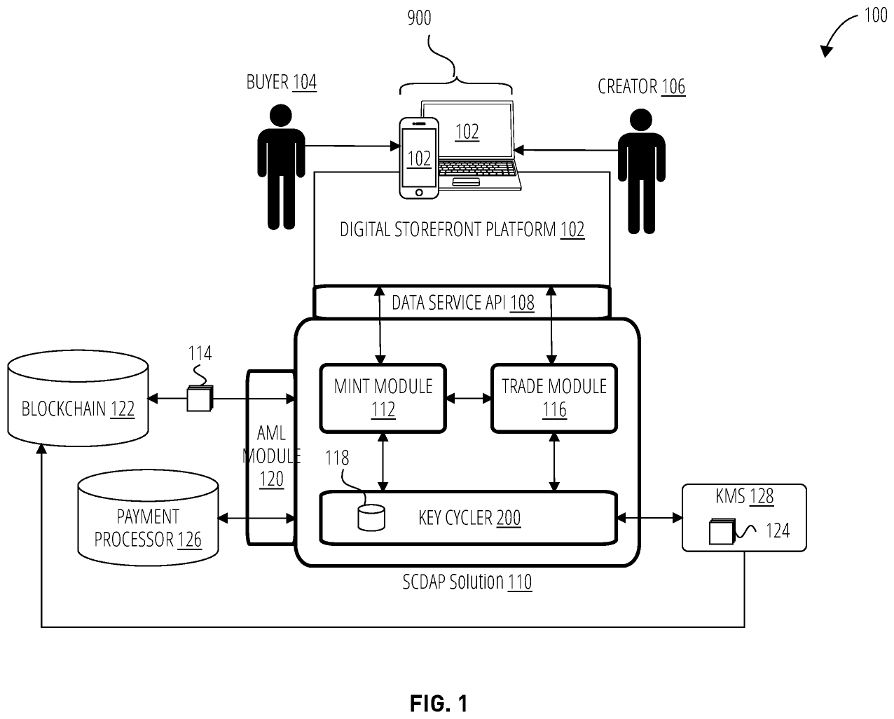

FIG. 1 illustrates SCDAP technical infrastructure 100 for operating a SCDAP solution 110 in accordance with one embodiment. The SCDAP technical infrastructure 100 may be provided as a product accessible through a web interface or an SDK. The SCDAP technical infrastructure 100 may include a digital storefront platform 102, accessed by buyers 104 and creators 106 via computing devices 900, a data service API 108, a mint module 112, a trade module 116, a key cycler 200, an AML module 120, a blockchain 122, and a payment processor 126 These components may be deployed across a combination of public cloud and private cloud computing platforms.

A digital storefront platform 102, such as an online marketplace, may allow users such as buyers 104 and creators 106 to interact with the SCDAP technical infrastructure 100. In the digital storefront platform 102, single NFTs or pack of NFTs created by creators 106 may be made available for sale to buyers 104. A number of digital storefront platforms 102 may operate with the disclosed SCDAP solution. The data service API 108 may allow the disclosed solution to be agnostic with respect to the digital storefront platforms 102 that implement it. That is, a number of digital storefront platforms 102 hosted by different providers may use the data service API 108 to integrate the disclosed SCDAP solution, independent from the hosting platform and base encoding of the individual digital storefront platform 102.

In one embodiment, a digital storefront platform 102 may provide access to the mint module 112. The mint module 112 may allow creators 106 to create and mint NFTs. Minting is the process of creating a new crypto asset and recording that information into a block that becomes part of a blockchain 122. Once an NFT asset is minted, it may be sent to the trade module 116. The trade module 116 may allow minted NFTs to be securely showcased, bought, sold, and transferred among buyers 104 and creators 106. The trade module 116 may handle all aspects of the transaction, such as currency transfer and transfer of ownership of NFT content data. The mint module 112 and trade module 116 may be implemented as a web interface, may be provided through an SDK, or may be made available to users via some other digital access implementation.

The key cycler 200 may allow the mint module 112 and the trade module 116 to interact with any blockchain 122 and payment processor 126 in a scalable fashion, by allowing multiple parallel transactions to be processed simultaneously with bank-grade security. Private keys 124 may be stored securely in a key management service 128, while the key cycler 200 may include database or cache 118 that contains a table associating private key indexes and their availability statuses. The index and status for each private key may allow the key cycler 200 to know which private keys 124 are available for use in a transaction while separating private keys 124 into the secure private storage offered by the key management service 128. Public keys 114 may be recorded on the blockchain 122.

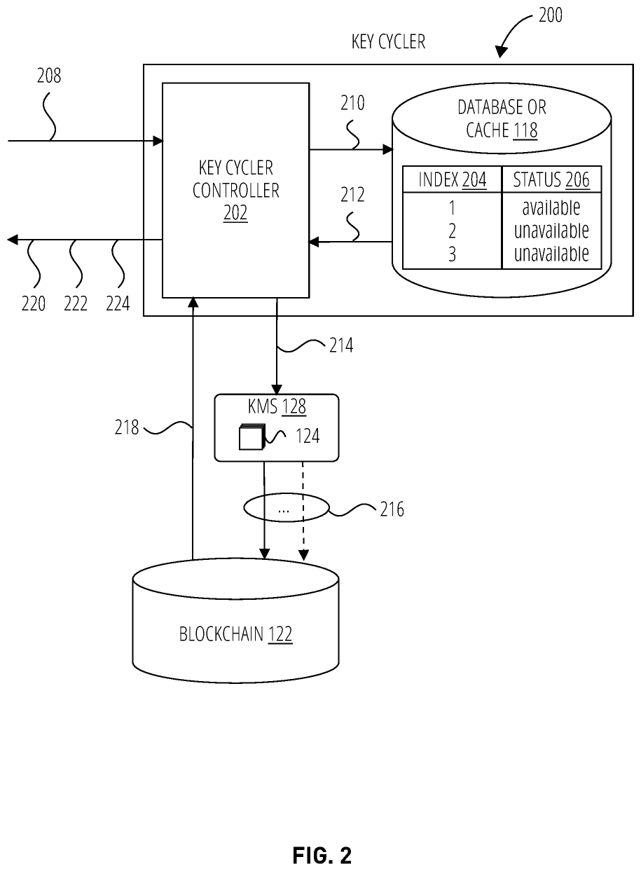

When multiple parallel transactions are desired, the key cycler 200 may first examine the database or cache 118 to find a private key 124 not in use. The private key 124 may be used to sign the parallel transactions, and may be released once the transactions have been sealed on the blockchain 122. If no private keys 124 are available, the system may wait until one becomes available. By alternating private keys stored in a key management service 128, thereby supporting parallel transactions, the key cycler 200 may represent a significant improvement in data flow. This is described in greater detail with regard to FIG. 2

Transactions in the SCDAP technical infrastructure 100 may utilize fiat currencies or cryptocurrencies. Every transaction and blockchain 122 wallet that interacts with the trade module 116 is screened against government sanctioned lists and a risk score is assigned to them based on historical on-chain activity and suspicious interactions. The AML module 120 may assign a risk score for each wallet that interacts with the trade module 116. The transactions may be screened and monitored by the AML module 120. The AML module 120 supports implementing a risk-based approach in applications that deploy it. The AML module 120 may flag and alert suspicious activity that may fall under money laundering or terrorism financing. The AML module 120 allows wallet screening, transaction monitoring, and enhanced due diligence. All activities are recorded and accessible through a web platform for any required post-incident investigations. In this manner, the AML module 120 may maintain AML and CFT regulatory compliance throughout operation of the solution. Interfacing with the AML module 120 may include incorporating a web interface or enacting a screening API, such as is described below.

```
url = ‘https://bei.anchain.com/api/address_risk_activity’
payload = {
  ‘proto’: ‘<PROTO>’,
  ‘address’: ′<ADDR>,
  ‘apikey’: ‘<APIKEY>’
}
res = requests.get(url=url, params=payload)
```

The above command returns JavaScript Object Notation (JSON) structured as follows:

```
{
  “data”: {
    “12t9YDPgwueZ9NyMgw519p7AAisjr6SMw”: {
      “activity”: {
        “suspicious_activity”: [
          {
            “aggr_type”: “entity”,
            “category”: “exchange”,
            “description”: “Received money from exchange:Zaif
wallet(s) 1 time”,
            “entity”: “Zaif”,
            “txn_cnt”: 1,
            “txn_direct”: 1,
            “txn_hashes”: [
              “a3b1559087dc216c7c5b...6f0”
            ],
            “txn_hashes_detail”: [
              {
                “suspicious_address”:
“1CZV316KMt9DR9kWFNje...mAr”,
                “txn_hash”: “a3b15590878dc216c7c5...e98”,
                “txn_timestamp”: 1494864282,
                “value”: 0.01290216
              }
            ],
            “txn_vol”: 0.01290216
          },
          {
            “aggr_type”: “entity”,
            “category”: “unaffiliated”,
            “description”: “Sent money to
unaffiliated:unaffiliated wallet(s) 2 times”,
            “entity”: “unaffiliated”,
            “txn_cnt”: 2,
            “txn_direct”: 0,
            “txn_hashes”: [
              “409803bb53123fd026c0...698”,
              “35e5d5fe8c81128cfa68...8a7”
            ],
            “txn_hashes_detail”: [
              {
                “suspicious_address”:
“16dfTuSx4f78eQ81PzTg...8Vy”,
                “txn_hash”: “35e5d5fe8c81128cfa68...8a7”,
                “txn_timestamp”: 1501735294,
                “value”: 9.02796322
              },
              {
                “suspicious_address”:
“1JC41YHmjKEcW1rLH6pm...hnC”,
                “txn_hash”: “409803bb53123fd026c0...698”,
                “txn_timestamp”: 1501734500,
                “value”: 0.01227173
              },
              {
                “suspicious_address”:
“1FQQ86tMuvhQ4Ruyggbb...gpY”,
                “txn_hash”: “409803bb53123fd026c0...698”,
                “txn_timestamp”: 1501734500,
                “value”: 8.71529348
              }
            ],
            “txn_vol”: 9.02796322
          }
        ],
        “suspicious_activity_declare”: “Suspicious Actibity is
sumarized based on most recent 2 transactions.”,
        “verdict_time”: 1509494400
      },
      “is_address_valid”: true,
      “risk”: {
        “level”: 4,
        “score”: 100,
        “verdict_time”: 1509494400,
      },
      “self”: {
        “category”: [
          “abuse”,
          “ransomware”,
        ],
        “detail”: [
          “ransomware:WannaCry”
        ]
      }
    }
  },
  “err_msg”: “”,
  “status”: 200
}
```

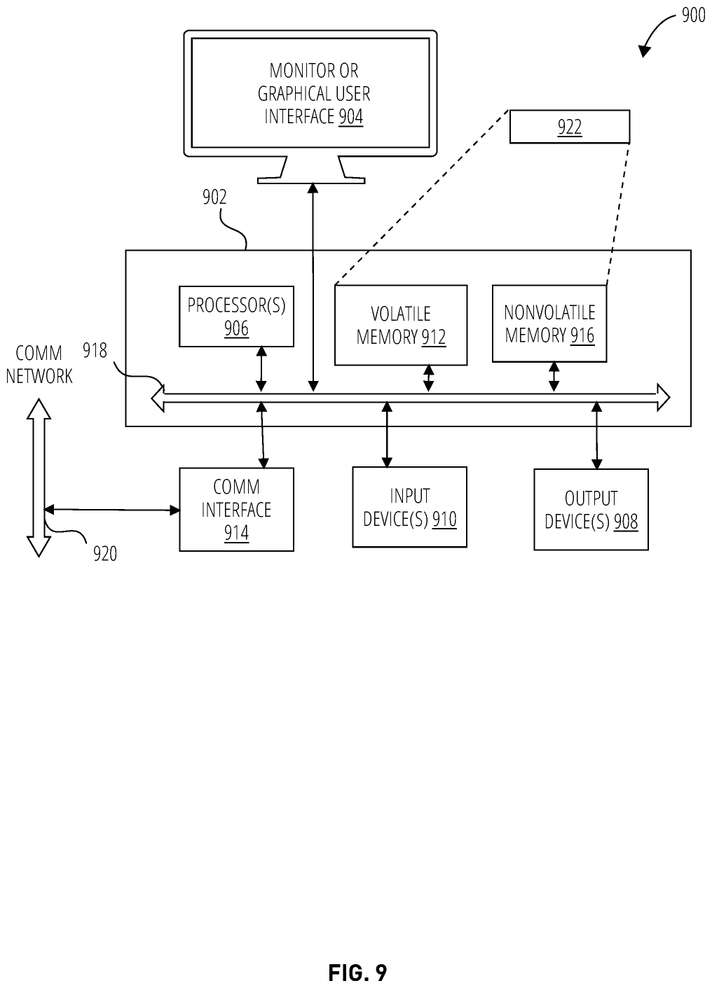

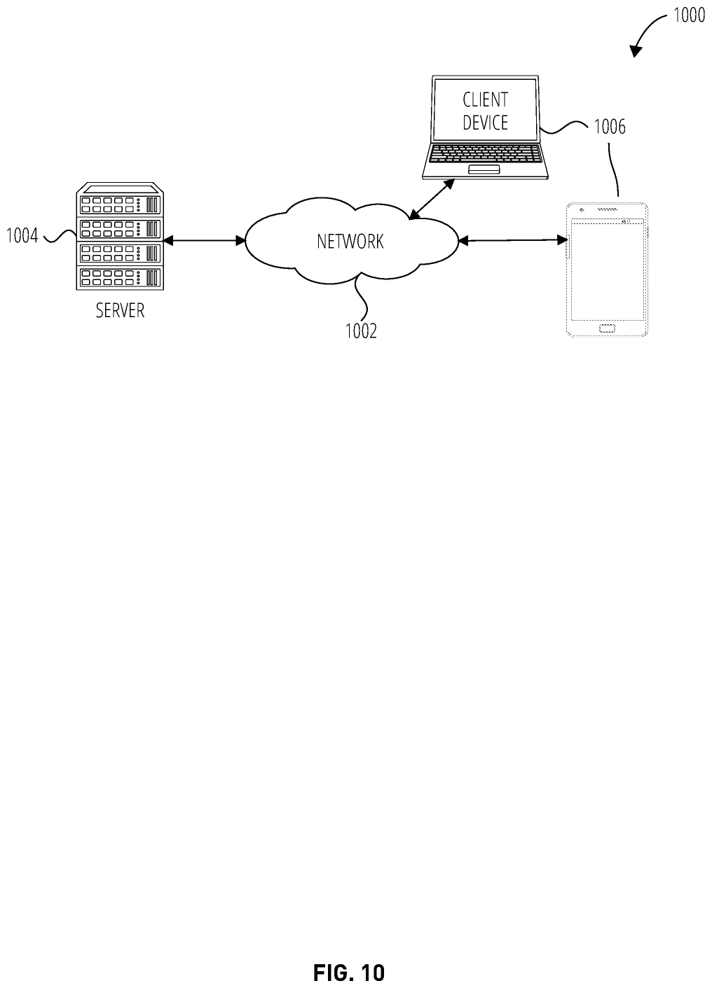

The buyers 104 and creators 106 may access their digital storefront platforms 102 through computing devices 900. Computing devices 900 may be smart mobile phones, tablets, laptops, desktop computing systems, etc. A general description of a computing device 900 capable of supporting implementation of the disclosed solution is provided in FIG. 9. These computing devices 900 may be integrated within a system 1000 such as is illustrated with respect to FIG. 10, allowing the computing devices 900, as client devices 1006 to access servers 1004, such as public clouds and private clouds used to deploy the disclosed solution, over a network 1002.

FIG. 2 illustrates a key cycler 200 in accordance with one embodiment. The key cycler 200 may comprise a key cycler controller 202 that executes actions within the key cycler 200 and a database or cache 118. The database or cache 118 may contain a table associating private key indices 204 with private key statuses 206, indicating whether each of the private keys associated with the private key indices 204 is available or unavailable for use.

In one embodiment, a transaction request signal 208 may be sent to the key cycler 200 through the action of a creator 106 or other user minting an NFT using the mint module 112 or offering an NFT for purchase using the trade module 116, or a buyer purchasing an NFT using the trade module 116. The key cycler controller 202 may authorize or validate the requested transaction, based, for example, on confirming a user's authorization to use an indicated payment account. For valid transactions, the key cycler controller 202 may send an available key query signal 210 to the database or cache 118. The 118 may inspect private key statuses 206 to identify available private keys. The database or cache 118 may return a key availability signal 212 to the key cycler controller 202. The key availability signal 212 may indicate that all private keys indexed are currently unavailable, or may indicate one or more private key indices 204 associated with private keys identified as available.

The key cycler controller 202 may send a signing key signal 214 to the key management service 128, indicating the index of the private key 124 or private keys 124 indicated as available by the key availability signal 212, in order to use these private keys 124 to sign the NFT transaction on the blockchain 122. The key management service 128 may send one or more transactional signature signals 216 to the blockchain 122. Each transactional signature signal 216 may include the private key 124 information needed to sign the desired transaction or each of a set of desired transactions.

Once the blockchain 122 has completed the transaction, it may return a transaction information signal 218 to the key cycler controller 202. The transaction information signal 218 may provide information about the completed transaction that the key cycler controller 202 may need to recognize the transaction as complete. For example, in one embodiment, the transaction information signal 218 may include information needed to recognize that the transfer of ownership and the transfer of currency are complete. The key cycler controller 202 may also update the private key indices 204 with the availability of the private keys 124 based on the transaction information signal 218, such as the data needed by the key cycler controller 202 to release a private key index 204 as available.

The key cycler controller 202 may finally return a transaction details signal 220 to the mint module 112, trade module 116, or whichever part of the system initiated the transaction. The transaction details signal 220 may include data that verifies the transaction initiated by the transaction request signal 208 is complete.

In one embodiment, the key cycler 200 may determine whether or not the transaction requested by the transaction request signal 208 proceeds. On condition the transaction proceeds, the key cycler 200 may send a transaction proceeds signal 222 to the mint module or trade module who's user action generated the transaction request signal 208. If the key cycler 200 determines the transaction requested by the transaction request signal 208 does not proceed, the key cycler 200 may send a transaction termination signal 224 to the mint module or trade module who's user action generated the transaction request signal.

The components described with respect to this figure may be hosted using a number of configurations without impeding the disclosed functionality. In one embodiment, these components may all be hosted on the blockchain 122. In another embodiment, they may be hosted on a cloud platform supported by a public or private cloud provider. In one embodiment, the key management service 128 storing private keys 124 may be an Amazon Web Services Key management service (AWS KMS) or a Hardware Security Module (HSM). The database or cache 118 that tracks private key availability may also be hosted on AWS.

A fiat payment provider may be integrated into this technical solution. For example, a marketplace integrating PayPal may be used as the digital storefront platform 102 indicated in FIG. 1 above, and payments may be carried out as the authentication performed by the key cycler controller 202. Thus, once a user pays with PayPal and payment is collected, the key cycler controller 202 may act to facilitate the process of sending a transaction to the blockchain 122 as previously described.

In this manner, the key cycler 200 may regulate the flow of data by acting as a gateway to the process of sending transactions. In particular, the key cycler may allow the flow of sending transactions to the blockchain to be regulated freely yet securely, representing a technical improvement over conventional solutions. For example, purchasing NFTs on a common blockchain such as Flow using common payment providers such as Stripe or PayPal through conventional systems may lead to severe performance bottlenecks. Without a key cycler, all payments may need to be processed sequentially.

Alternatively, a more sophisticated payment provider such as Dapper Wallet or Moonpay may need to be integrated into the NFT minting and trading solution, which may be very time-consuming. Otherwise, only cryptocurrency payment options may be supportable, which may be inconveniently restrictive for creators and buyers. The key cycler 200 may correct these problems by allowing for parallel processing of payments. The key cycler 200 may permit users of common payment gateways to purchase NFTs with traditional fiat currency while preventing the performance impacts faced by conventional solutions which may only allow one blockchain purchase to occur at a time.

The disclosed key cycler 200 is specifically designed to improve NFT minting and trading using blockchains that may reject transactions when two or more transactions are signed by a single account in parallel. By design, such blockchains may reject one or more transactions in order to defend against transaction replay attacks. This means that if multiple transactions from one account are to be processed using one key, such as when a creator desires to mint a collection of NFTs, or a buyer desires to purchase a collection, or multiple NFTs at once in some other configuration, the system used to complete these transactions may need to wait for all of the requested transactions to occur sequentially, which is not ideal in many situations, especially transactions involving high-traffic sites. The key cycler 200 solves this problem by allowing applications to perform parallel processing of transactions from a single account, each transaction provided its own key from the set of keys managed by the key cycler 200. This may allow for on-demand minting solutions and integration with common payment gateways allowing users to purchase NFTs with traditional fiat currency while not being impacted by common performance problems faced by only allowing one purchase to occur at a time.

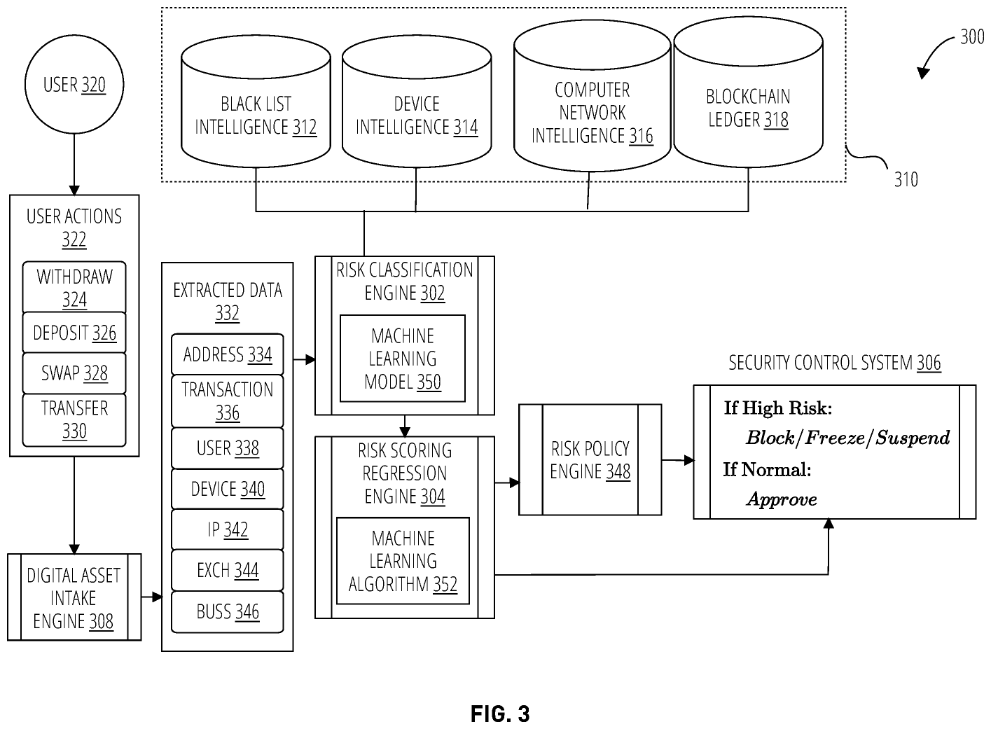

FIG. 3 illustrates a system 300 for blockchain transaction risk management that may be used for the AML module 120 that is part of the AML module. The system 300 comprises a digital asset intake engine 308, a risk classification engine 302, a risk scoring regression engine 304, a risk policy engine 348, a security control system 306, and an entity knowledge base engine 310. The risk classification engine 302 comprises a machine learning model 350. The risk scoring regression engine 304 comprises a machine learning algorithm 352. The entity knowledge base engine 310 comprise a black list intelligence database 312, a device intelligence database 314, a computer network intelligence database 316, and a blockchain ledger 318.

The digital asset intake engine 308 is configured to receive digital on blockchain information and digital off blockchain information, and extract digital data from the digital on blockchain information and the digital off blockchain information. The entity knowledge base engine 310 is configured to contextualize relationships based on the digital data and the digital off blockchain information and the digital on blockchain information. The risk classification engine 302 includes a machine learning model and is configured to analyze the digital data and transform the digital data to an identified behavior category, thereby creating classified risk data. The risk scoring regression engine 304 includes machine learning and is configured to analyze the classified risk data and assign a risk score to each classified risk data.

The risk policy engine 348 is a rules based engine. The security control system 306 configured to take an action on the digital on blockchain information and digital off blockchain information based on the assigned risk score.

In the system 300, a user 320 performs a set of user actions 322 comprising a withdraw 324, a deposit 326, a swap 328, and/or a transfer 330, of funds or cryptocurrency. These actions are understood as digital on blockchain information and digital off blockchain information and are received by a digital asset intake engine 308. The digital asset intake engine 308 extracts data (extracted data 332), which pulls out the digital data and the digital off blockchain information and the digital on blockchain information that includes a blockchain address 334, a transaction identification 336, a user information 338, a device information 340, a business type 346, and a device IP address 342, as well as the exchange or custodian information 344, associated with the user 320's actions. The data pulled by the digital asset intake engine 308 may be obtained from the cryptocurrency exchange where the user actions 322 were performed or other sources that track these actions. The extracted digital data and the digital off blockchain information and the digital on blockchain information is then contextualized by a risk classification engine 302, which leverages information stored in entity knowledge bases that include black list intelligence database 312, a device intelligence database 314, a computer network intelligence database 316, and a blockchain ledger 318. The risk classification engine 302 analyzes the information stored in the entity knowledge bases to transform the digital data into an identified behavior category, creating classified risk data. The classified risk data is then communicated to a risk scoring regression engine 304 that analyzes the classified risk data and assigns a risk score to each classified risk data. The classified risk data is then communicated to the risk policy engine 348, which is a rules based engine. The classified risk data is then analyzed by the risk policy engine 348 to determine if any deviations from rules or standards have or will occur. The security control system 306 takes an action on the digital on blockchain information and digital off blockchain information based on the assigned risk score and any deviations from rules or standards. For example, if the risk is high, the security control system 306 may block, freeze, or suspend the transaction and/or the account that is performing the actions. If the risk is viewed as normal, the security control system 306 may approve the transaction.

The AML module may comprise additional features, including those disclosed in U.S. Non-Provisional patent application Ser. No. 17/006,431, filed Aug. 28, 2020, titled System and Method for Blockchain Transaction Risk Management Using Machine Learning, the entire contents of which are incorporated herein by reference.

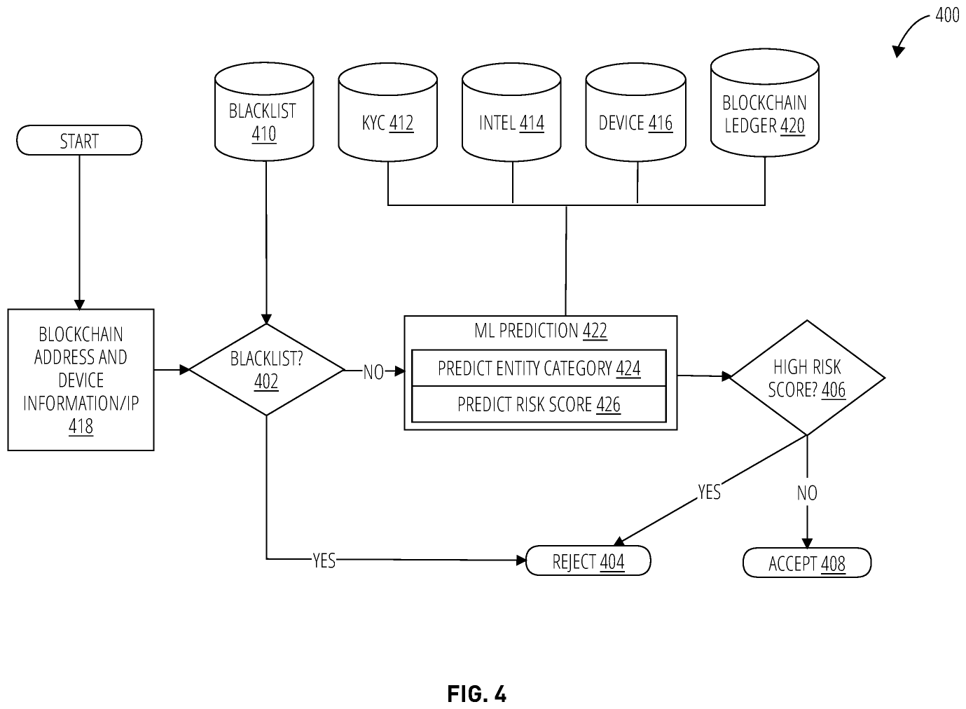

FIG. 4 illustrates a flow chart for process 400 describing machine learning (ML) Entity categorization and risk engine processes that may be used for the AML module 120. In the process 400, blockchain address and device information/IP 418 is received following user action on the blockchain or associated with the blockchain on a cryptocurrency exchange. At decision block 402, the blockchain address and device information/IP 418 is analyzed against a blacklist database 410 and a determination is made whether the blockchain address and device information/IP 418 have been blacklisted from operating on the exchange. If the blockchain address and device information/IP 418 has been blacklisted according to the blacklist database 410, the process 400 moves to reject 404 the user action on the exchange. If the blockchain address and device information/IP 418 has not been blacklisted the process moves to block 422 where a machine learning prediction is performed. The machine learning prediction utilizes an entity knowledge base comprising an identity verification database 412, a computer network intelligence database 414, a device intelligence database 416, and the blockchain ledger 420 to predict entity category 424 and predict risk score 426. The process 400 then moves to decision block 406 that determines if the predicted risk score is high. If the risk score is high, the process 400 moves to reject 404 the user action. If the risk score is not high, the process 400 moves to accept 408 the user action.

In one embodiment, on condition the risk score is high the blockchain transaction may be blocked, user assets may be frozen, or user accounts related to the blockchain transaction may be frozen. On condition the risk score is normal, the blockchain transaction may be approved.

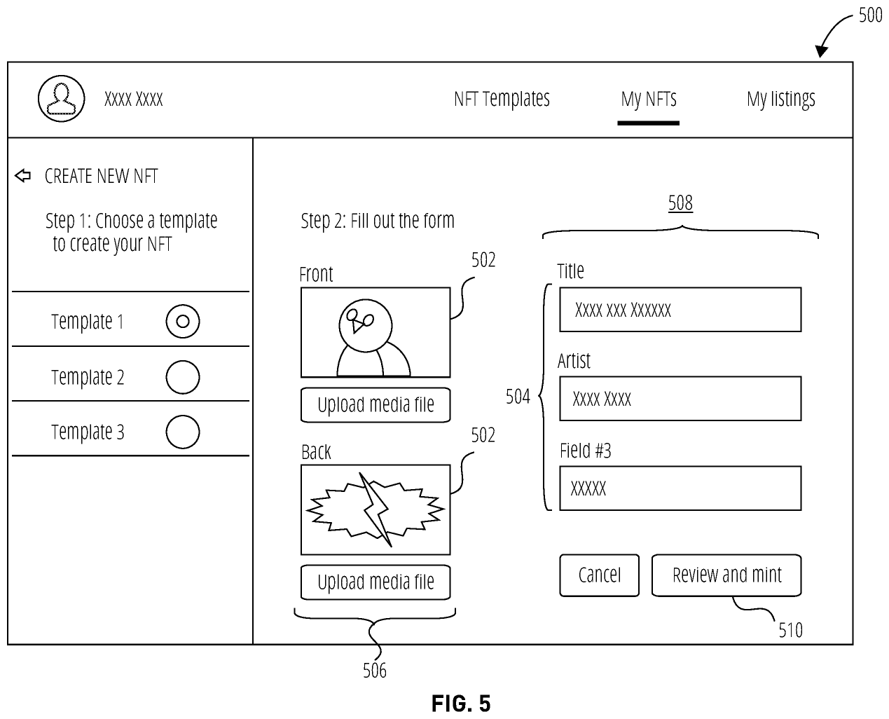

FIG. 5 illustrates an interface for creating and minting an NFT with the mint module 500 in accordance with one embodiment. The interface for creating and minting an NFT with the mint module 500 may comprise an enter NFT content control 506, an enter NFT metadata control 508, and a mint NFT with mint module control 510.

The enter NFT content control 506 may allow a creator to upload NFT content 502. The enter NFT metadata control 508 may allow the creator 106 to assign NFT metadata 504 for the NFT. The creator 106 may then use the mint module 112 to create a minted NFT by interacting with the mint NFT with mint module control 510.

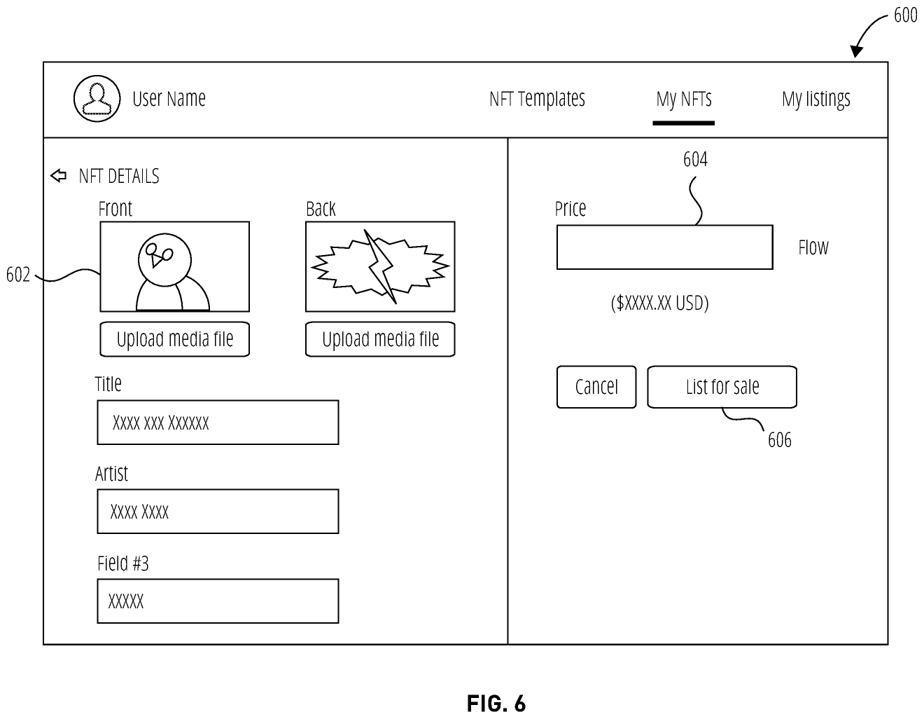

FIG. 6 illustrates an interface for listing minted NFTs for trade with the trade module 600 in accordance with one embodiment. The interface for listing minted NFTs for trade with the trade module 600 may comprise a display showing data for a minted NFT 602 with additional controls for modifying its associated data as needed. The interface for listing minted NFTs for trade with the trade module 600 may also comprise an NFT price control 604, allowing the creator 106 to assign a cryptocurrency or fiat currency price for the NFT. Once a price for a minted NFT has been assigned, the creator 106 may actuate the send minted NFT to trade module control 606. This may send the NFT to the trade module 116 to be listed for sale or transfer among buyers 104.

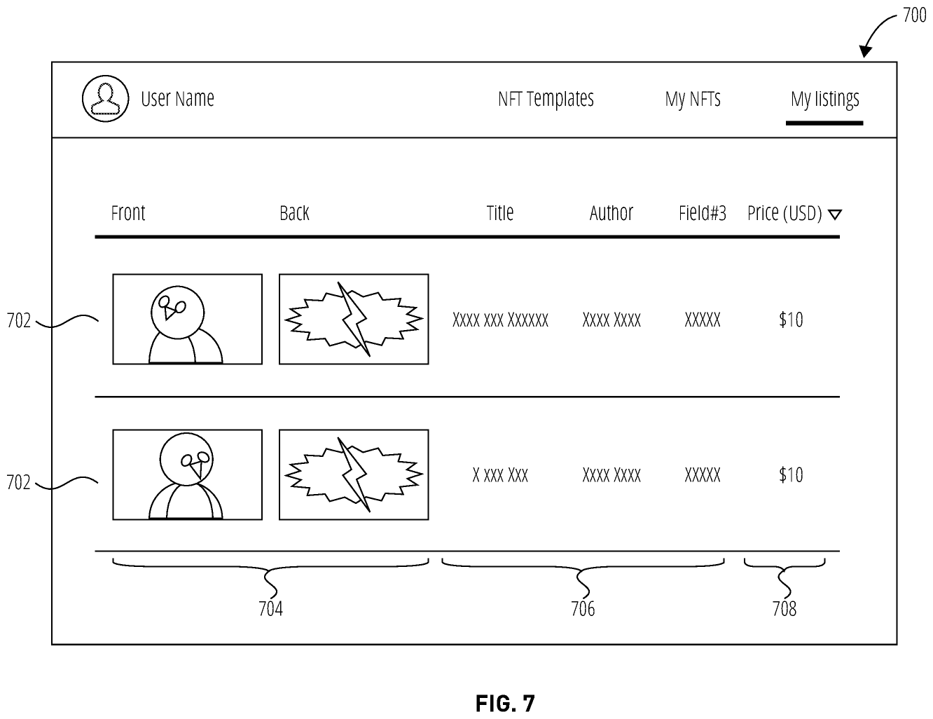

FIG. 7 illustrates an interface for listing minted NFTs for trade with the trade module 700 in accordance with one embodiment. The interface for listing minted NFTs for trade with the trade module 700 may comprise a minted NFT listed for purchase 702, displaying NFT content 704, an NFT metadata 706, and an NFT listed sale price 708.

The minted NFTs listed for purchase 702 may arrive at the trade module 116 through a creator 106 interacting with the interface for creating and minting an NFT with the mint module 500 and interface for listing minted NFTs for trade with the trade module 600. The interface for listing minted NFTs for trade with the trade module 700 may allow the creator 106 to view, review, and in some embodiments modify the minted NFT listed for purchase 702 associated with that creator 106 and listed for sale or transfer by the trade module 116.

A similar listing format may be configured to display the NFT content 704, NFT metadata 706, and NFT listed sale price 708 for minted NFTs listed for purchase 702 to buyers 104. Buyers 104 may be able to filter by NFT metadata 504, NFT listed sale price 708, across a library of minted NFTs listed for purchase 702 by multiple creators 106.

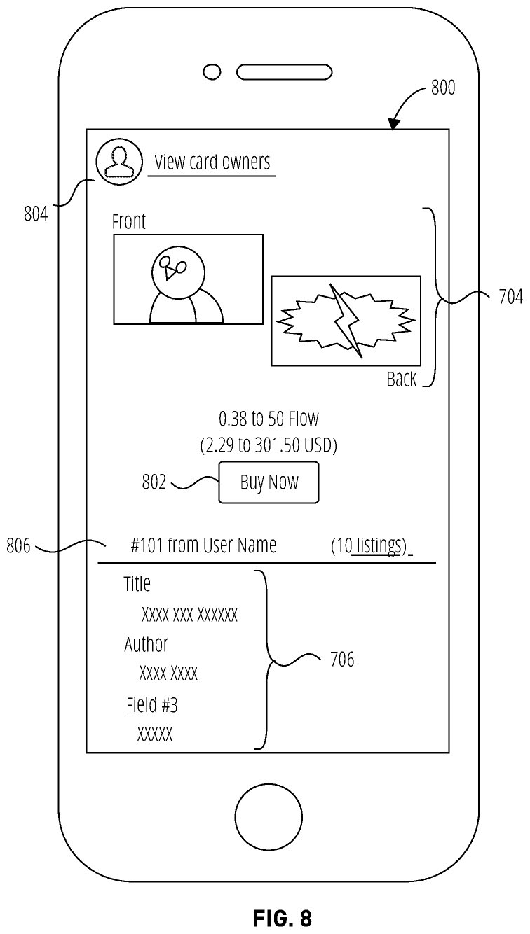

FIG. 8 illustrates a digital storefront platform interface 800 in accordance with one embodiment. The digital storefront platform interface 800 may display NFT content 704, NFT metadata 706, and NFT listed sale price 708 for a minted NFT listed for purchase 702. The digital storefront platform interface 800 may also include a purchase control 802 allowing a buyer 104 to purchase the minted NFT listed for purchase 702 by a seller, who may be a creator 106 or another person, user, or entity who ones the NFT content 704.

In one embodiment, the digital storefront platform interface 800 may include a card owners control 804 allowing a prospective buyer 104 to view information about one or more people who have owned or currently own the minted NFT listed for purchase 702. The digital storefront platform interface 800 may also include creator information 806, allowing a buyer 104 to learn more about the person who created the NFT, their previous creations and sales, an interaction rating, trending popularity, or other data that may be of interest to a prospective NFT buyer 104.

FIG. 9 is an example block diagram of a computing device 900 that may incorporate embodiments of the present invention. FIG. 9 is merely illustrative of a machine system to carry out aspects of the technical processes described herein, and does not limit the scope of the claims. One of ordinary skill in the art would recognize other variations, modifications, and alternatives. In one embodiment, the computing device 900 typically includes a monitor or graphical user interface 904, a data processing system 902, a communication network interface 914, input device(s) 910, output device(s) 908, and the like.

As depicted in FIG. 9, the data processing system 902 may include one or more processor(s) 906 that communicate with a number of peripheral devices via a bus subsystem 918. These peripheral devices may include input device(s) 910, output device(s) 908, communication network interface 914, and a storage subsystem, such as a volatile memory 912 and a nonvolatile memory 916.

The volatile memory 912 and/or the nonvolatile memory 916 may store computer-executable instructions and thus forming logic 922 that when applied to and executed by the processor(s) 906 implement embodiments of the processes disclosed herein.

The input device(s) 910 include devices and mechanisms for inputting information to the data processing system 902. These may include a keyboard, a keypad, a touch screen incorporated into the monitor or graphical user interface 904, audio input devices such as voice recognition systems, microphones, and other types of input devices. In various embodiments, the input device(s) 910 may be embodied as a computer mouse, a trackball, a track pad, a joystick, wireless remote, drawing tablet, voice command system, eye tracking system, and the like. The input device(s) 910 typically allow a user to select objects, icons, control areas, text and the like that appear on the monitor or graphical user interface 904 via a command such as a click of a button or the like.

The output device(s) 908 include devices and mechanisms for outputting information from the data processing system 902. These may include the monitor or graphical user interface 904, speakers, printers, infrared LEDs, and so on as well understood in the art.

The communication network interface 914 provides an interface to communication networks (e.g., communication network 920) and devices external to the data processing system 902. The communication network interface 914 may serve as an interface for receiving data from and transmitting data to other systems. Embodiments of the communication network interface 914 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 914 may be coupled to the communication network 920 via an antenna, a cable, or the like. In some embodiments, the communication network interface 914 may be physically integrated on a circuit board of the data processing system 902, or in some cases may be implemented in software or firmware, such as “soft modems”, or the like.

The computing device 900 may include logic that enables communications over a network using protocols such as HTTP, TCP/IP, RTP/RTSP, IPX, UDP and the like.

The volatile memory 912 and the nonvolatile memory 916 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 912 and the nonvolatile memory 916 may be configured to store the basic programming and data constructs that provide the functionality of the disclosed processes and other embodiments thereof that fall within the scope of the present invention.

Logic 922 that implements embodiments of the present invention may be stored in the volatile memory 912 and/or the nonvolatile memory 916. Said logic 922 may be read from the volatile memory 912 and/or nonvolatile memory 916 and executed by the processor(s) 906. The volatile memory 912 and the nonvolatile memory 916 may also provide a repository for storing data used by the logic 922.

The volatile memory 912 and the nonvolatile memory 916 may include a number of memories including a main random access memory (RAM) for storage of instructions and data during program execution and a read only memory (ROM) in which read-only non-transitory instructions are stored. The volatile memory 912 and the nonvolatile memory 916 may include a file storage subsystem providing persistent (non-volatile) storage for program and data files. The volatile memory 912 and the nonvolatile memory 916 may include removable storage systems, such as removable flash memory.

The bus subsystem 918 provides a mechanism for enabling the various components and subsystems of data processing system 902 communicate with each other as intended. Although the communication network interface 914 is depicted schematically as a single bus, some embodiments of the bus subsystem 918 may utilize multiple distinct busses.

It will be readily apparent to one of ordinary skill in the art that the computing device 200 may be a device such as a smartphone, a desktop computer, a laptop computer, a rack-mounted computer system, a computer server, or a tablet computer device. As commonly known in the art, the computing device 900 may be implemented as a collection of multiple networked computing devices. Further, the computing device 900 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g., read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

FIG. 10 illustrates a system 1000 in which a server 1004 and a client device 1006 are connected to a network 1002.

In various embodiments, the network 1002 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, the network 1002 may also include a voice network that conveys not only voice communications, but also non-voice data such as Short Message Service (“SMS”) messages, as well as data communicated via various cellular data communication protocols, and the like.

In various embodiments, the client device 1006 may include desktop PCs, mobile phones, laptops, tablets, wearable computers, or other computing devices 900 as described with respect to FIG. 9 that are capable of connecting to the network 1002 and communicating with the server 1004, such as described herein.

In various embodiments, additional infrastructure (e.g., short message service centers, cell sites, routers, gateways, firewalls, and the like), as well as additional devices may be present. Further, in some embodiments, the functions described as being provided by some or all of the server 1004 and the client device 1006 may be implemented via various combinations of physical and/or logical devices. However, it is not necessary to show such infrastructure and implementation details in FIG. 10 in order to describe an illustrative embodiment.

Cloud computing platforms such as the public clouds and/or private clouds used to implement the SCDAP technical infrastructure 100 as described in FIG. 1 may utilize one or more cloud-based servers 1004 accessible by computing devices 900 connected to a network 1002 having access to the Internet. Public Cloud solutions may include Amazon Web Services (AWS), InterPlanetary File System (IPFS), and similar systems.

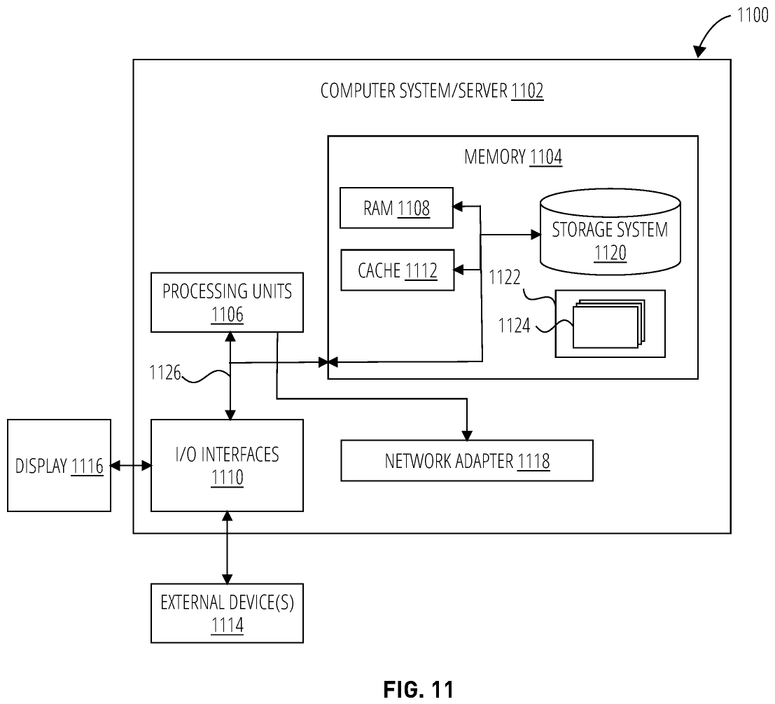

As shown in FIG. 11, computer system/server 1102 in a Cloud computing node 1100 is shown in the form of a general-purpose computing device. The components of computer system/server 1102 may include, but are not limited to, one or more processors or processing units 1106, a system memory 1104, and a bus 1126 that couples various system components including system memory 1104 to processor processing units 1106. The computer system/server 1102 may be a computing apparatus configured to process data from a non-transitory computer-readable storage medium, the computer-readable storage medium.

Bus 1126 represents one or more of any of several types of bus structures, including a memory bus or memory controller, a peripheral bus, an accelerated graphics port, and a processor or local bus using any of a variety of bus architectures. By way of example, and not limitation, such architectures include Inter-Integrated Circuit (I2C), Serial Peripheral Interface (SPI), Controller Area Network (CAN), Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1102 typically includes a variety of computer system readable media. Such media may be any available media that is accessible by computer system/server 1102, and it includes both volatile and non-volatile media, removable and non-removable media.

System memory 1104 may include computer system readable media in the form of volatile memory, such as Random access memory (RAM) 1108 and/or cache memory 1112. Computer system/server 1102 may further include other removable/non-removable, volatile/non-volatile computer system storage media. By way of example only, a storage system 1120 may be provided for reading from and writing to a non-removable, non-volatile magnetic media (not shown and typically called a “hard drive”). Although not shown, a a flash drive, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media may be provided. In such instances, each may be connected to bus 1126 by one or more data media interfaces. As will be further depicted and described below, system memory 1104 may include at least one program product having a set (e.g., at least one) of program modules that are configured to carry out the functions of the invention.

Program/utility 1122 having a set (at least one) of program modules 1124 may be stored in system memory 1104 by way of example, and not limitation, as well as an operating system, one or more application programs, other program modules, and program data. Each of the operating system, one or more application programs, other program modules, and program data or some combination thereof, may include an implementation of a networking environment. Program modules 1124 generally carry out the functions and/or methodologies of the invention as described herein.

Computer system/server 1102 may also communicate with one or more external devices 1114 such as a keyboard, a pointing device, a display 1116, etc.; one or more devices that enable a user to interact with computer system/server 1102; and/or any devices (e.g., network card, modem, etc.) that enable computer system/server 1102 to communicate with one or more other computing devices. Such communication may occur via I/O interfaces 1110. I/O interfaces 1110 may also manage input from sensors and peripheral connected wirelessly or through wired connection with the computer system/server 1102, as well as output to actuators and peripherals also so connected.

Still yet, computer system/server 1102 may communicate with one or more networks such as a local area network (LAN), a general wide area network (WAN), and/or a public network (e.g., the Internet) via network adapter 1118. As depicted, network adapter 1118 communicates with the other components of computer system/server 1102 via bus 1126. \

It will be understood that although not shown, other hardware and/or software components may be used in conjunction with computer system/server 1102. Examples include, but are not limited to: microcode, device drivers, redundant processing units, external disk drive arrays, RAID systems, tape drives, and data archival storage systems, etc.

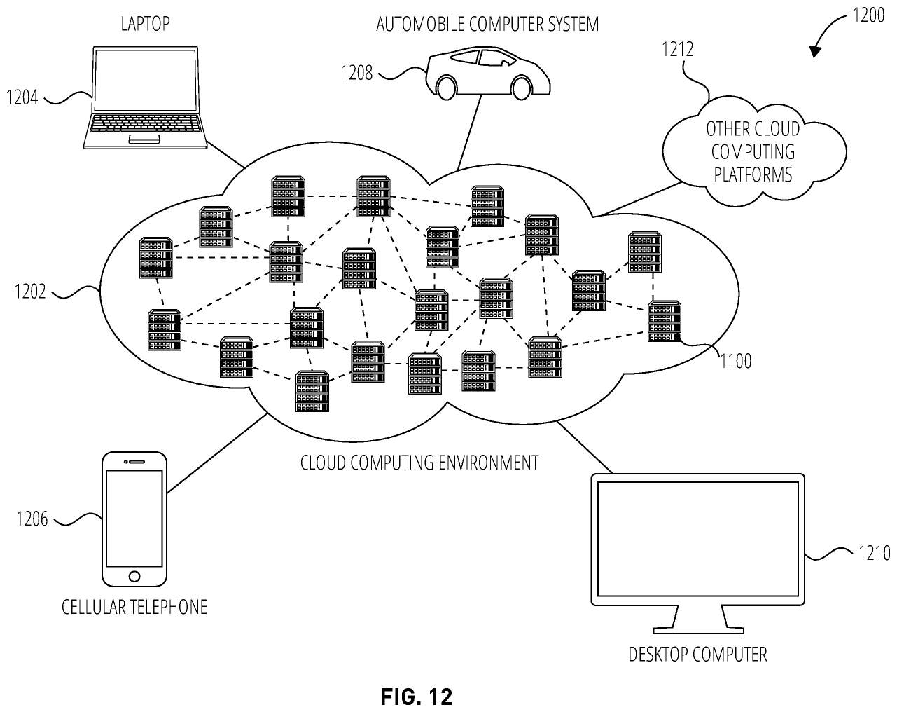

Referring now to FIG. 12, an illustrative Cloud computing environment 1202 is depicted in a Cloud computing system 1200. “Cloud computing” in this disclosure refers to a model for enabling convenient, on-demand network access to a shared pool of configurable computing resources (e.g., networks, servers, storage, applications, and services) that can be rapidly provisioned and released with minimal management effort or service provider interaction. This cloud model promotes availability and is comprised of at least five characteristics, at least three service models, and at least four deployment models. Examples of commercially hosted Cloud computing systems 1200 include Amazon Web Services (AWS), Google Cloud, Microsoft Azure, etc.

As shown, Cloud computing environment 1202 comprises one or more Cloud computing nodes 1100 with which computing devices such as, for example, laptops 1204, personal digital assistants (PDAs) or cellular telephones 1206, automobile computer systems 1208, desktop computers 1210, and other Cloud computing platforms 1212, may communicate.

This allows for infrastructure, platforms, and/or software to be offered as services from Cloud computing environment 1202, so as to not require each client to separately maintain such resources. It is understood that the types of computing devices shown in FIG. 12 are intended to be illustrative only and that Cloud computing environment 1202 may communicate with any type of computerized device over any type of network and/or network/addressable connection (e.g., using a web browser).

Cloud computing is a model of service delivery for enabling convenient, on-demand network access to a shared pool of configurable computing resources (e.g., networks, network bandwidth, servers, processing, memory, storage, applications, virtual machines, and services) that may be rapidly provisioned and released with minimal management effort or interaction with a provider of the service. This cloud model may include at least five characteristics, at least three service models, and at least four deployment models.

Characteristics are as follows:

“On-demand self-service” in this disclosure refers to a consumer can unilaterally provision computing capabilities, such as server time and network storage, as needed, automatically without requiring human interaction with each service's provider.

“Broad network access” in this disclosure refers to capabilities that are available over a network and accessed through standard mechanisms that promote use by heterogeneous thin or thick client platforms (e.g., mobile phones, laptops, and PDAs).

“Resource pooling” in this disclosure refers to the provider's computing resources are pooled to serve multiple consumers using a multi-tenant model, with different physical and virtual resources dynamically assigned and reassigned according to consumer demand. There is a sense of location independence in that the customer generally has no control or knowledge over the exact location of the provided resources but may be able to specify location at a higher level of abstraction (e.g., country, state, or datacenter). Examples of resources include storage, processing, memory, network bandwidth, and virtual machines.

“Rapid elasticity” in this disclosure refers to capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

“Measured service” in this disclosure refers to cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

“Cloud Software as a Service (SaaS)” in this disclosure refers to the capability provided to the consumer is to use the provider's applications running on a Cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

“Cloud Platform as a Service (PaaS)” in this disclosure refers to the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

“Cloud Infrastructure as a Service (IaaS)” in this disclosure refers to the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

“Private cloud” in this disclosure refers to the cloud infrastructure is operated solely for an organization. It may be managed by the organization or a third party and may exist on-premises or off-premises.

“Community cloud” in this disclosure refers to the cloud infrastructure is shared by several organizations and supports a specific community that has shared concerns (e.g., mission, security requirements, policy, and compliance considerations). It may be managed by the organizations or a third party and may exist on-premises or off-premises.

“Public Cloud” in this disclosure refers to the cloud infrastructure is made available to the general public or a large industry group and is owned by an organization selling cloud services.

“Hybrid Cloud” in this disclosure refers to the cloud infrastructure is a composition of two or more clouds (private, community, or public) that remain unique entities but are bound together by standardized or proprietary technology that enables data and application portability (e.g., cloud bursting for load-balancing between Clouds).

A Cloud computing environment 1202 may be service oriented with a focus on statelessness, low coupling, modularity, and semantic interoperability. At the heart of Cloud computing is an infrastructure that includes a network of interconnected nodes. It is to be understood that although this disclosure includes a detailed description on Cloud computing, implementation of the teachings recited herein are not limited to a Cloud computing environment. Rather, embodiments of the present disclosure are capable of being implemented in conjunction with any other type of computing environment now known or later developed.

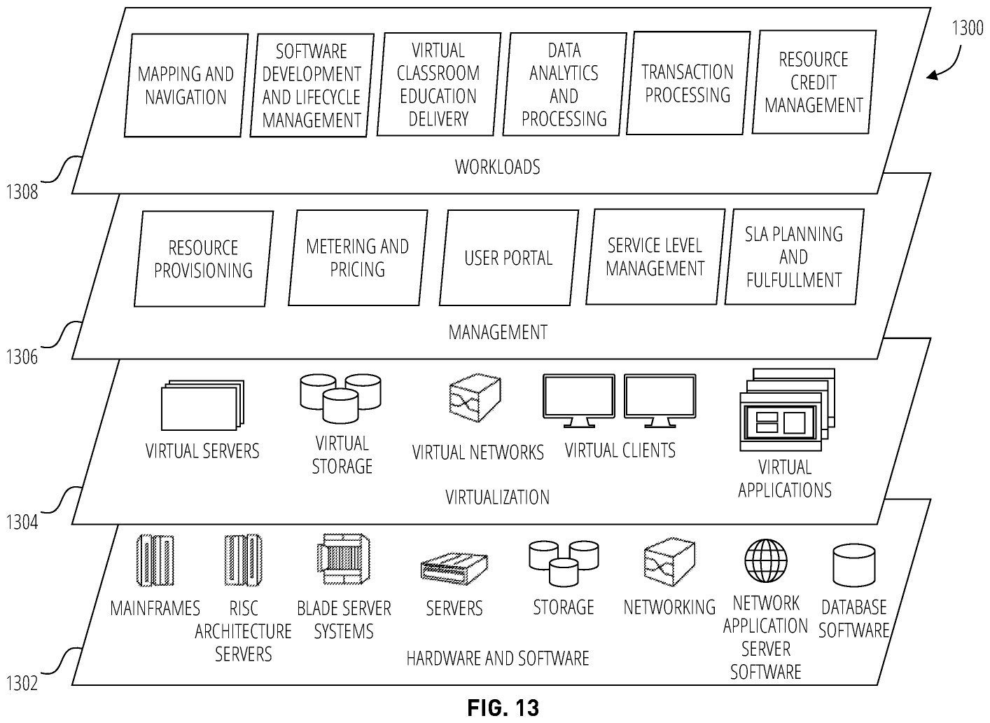

Referring now to FIG. 13, a set of functional abstraction layers provided by Cloud computing systems 1200 such as those illustrated in FIG. 12 is shown. It should be understood in advance that the components, layers, and functions shown in FIG. 13 are intended to be illustrative only, and the invention is not limited thereto. As depicted, the following layers and corresponding functions are provided:

Hardware and software layer 1302 includes hardware and software components. Examples of hardware components include mainframes, reduced instruction set computer (RISC) architecture based servers, servers, blade servers, storage devices, and networks and networking components. Examples of software components include network application server software and database software.

Virtualization layer 1304 provides an abstraction layer from which the following exemplary virtual entities may be provided: virtual servers; virtual storage; virtual networks, including virtual private networks; virtual applications; and virtual clients.

Management layer 1306 provides the exemplary functions described below. Resource provisioning provides dynamic procurement of computing resources and other resources that are utilized to perform tasks within the Cloud computing environment. Metering and Pricing provide cost tracking as resources are utilized within the Cloud computing environment, and billing or invoicing for consumption of these resources. In one example, these resources may comprise application software licenses. Security provides identity verification for users and tasks, as well as protection for data and other resources. User portal provides access to the Cloud computing environment for both users and system administrators. Service level management provides Cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 1308 provides functionality for which the Cloud computing environment is utilized. Examples of workloads and functions which may be provided from this layer include: mapping and navigation; software development and lifecycle management; virtual classroom education delivery; data analytics processing; transaction processing; and resource credit management. As mentioned above, all of the foregoing examples described with respect to FIG. 13 are illustrative only, and the invention is not limited to these examples.

### LISTING OF DRAWING ELEMENTS

100 SCDAP technical infrastructure
102 digital storefront platform
104 buyer
106 creator
108 data service API
110 SCDAP solution
112 mint module
114 public key
116 trade module
118 database or cache
120 AML module
122 blockchain
124 private key
126 payment processor
128 key management service
200 key cycler
202 key cycler controller
204 private key index
206 private key status
208 transaction request signal
210 available key query signal
212 key availability signal
214 signing key signal
216 transactional signature signal
218 transaction information signal
220 transaction details signal
222 transaction proceeds signal
224 transaction termination signal
300 system
302 risk classification engine
304 risk scoring regression engine
306 security control system
308 digital asset intake engine
310 entity knowledge base engine
312 black list intelligence database
314 device intelligence database
316 computer network intelligence database
318 blockchain ledger
320 user
322 user actions
324 withdraw
326 deposit
328 swap
330 transfer
332 extracted data
334 blockchain address
336 transaction identification
338 user information
340 device information
342 device IP address
344 exchange or custodian information
346 business type
348 risk policy engine
350 machine learning model
352 machine learning algorithm
400 process
402 decision block
404 reject
406 decision block
408 accept
410 blacklist database
412 identity verification database
414 computer network intelligence database
416 device intelligence database
418 blockchain address and device information/IP
420 blockchain ledger
422 block
424 predict entity category
426 predict risk score
500 interface for creating and minting an NFT with the mint module
502 NFT content
504 NFT metadata
506 enter NFT content control
508 enter NFT metadata control
510 mint NFT with mint module control
600 interface for listing minted NFTs for trade with the trade module
602 minted NFT
604 NFT price control
606 send minted NFT to trade module control
700 interface for listing minted NFTs for trade with the trade module
702 minted NFT listed for purchase
704 NFT content
706 NFT metadata
708 NFT listed sale price
800 digital storefront platform interface
802 purchase control
804 card owners control
806 creator information
900 computing device
902 data processing system
904 monitor or graphical user interface
906 processor(s)
908 output device(s)
910 input device(s)
912 volatile memory
914 communication network interface
916 nonvolatile memory
918 bus subsystem
920 communication network
922 logic
1000 system
1002 network
1004 server
1006 client device
1100 Cloud computing node
1102 computer system/server
1104 system memory
1106 processing units
1108 Random access memory (RAM)
1110 I/O interfaces
1112 cache memory
1114 external devices
1116 display
1118 network adapter
1120 storage system
1122 program/utility
1124 program modules
1126 bus
1200 Cloud computing system
1202 Cloud computing environment
1204 laptop
1206 cellular telephone
1208 automobile computer system
1210 desktop computer
1212 other Cloud computing platforms
1300 Cloud computing functional abstraction layers
1302 hardware and software layer
1304 virtualization layer
1306 management layer
1308 workloads layer

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the disclosure as claimed. The scope of disclosed subject matter is not limited to the depicted embodiments but is rather set forth in the following Claims.

What is claimed is:

1. A method of offering blockchain transactions of non-fungible tokens (NFTs), the method comprising:
providing a digital storefront platform for the NFTs, wherein the NFTs include smart contract-based digital assets,
the digital storefront platform including:
a mint module configured to create and mint NFTs on blockchains;
a trade module configured to transact with the minted NFTs;
a key cycler configured to allow parallel transactions with blockchains, payment processors, the mint module, and the trade module, the key cycler including:
a key cycler controller for executing actions within the key cycler and facilitating the parallel transactions including at least one of the blockchains, the payment processors, the mint module, and the trade module;
a plurality of private keys on a web-based key management service (KMS);
indices of the plurality of private keys; and
a database including the indices and a status of each private key of the plurality of private keys, wherein the status includes available or unavailable;
receiving a request from a user to create and mint at least one new NFT on a blockchain, using the mint module;
creating and minting the at least one new NFT;
listing for sale, using the trade module, the minted at least one new NFT on the digital storefront platform;
transacting between a buyer and a seller, with the minted at least one new NFTs including performing the parallel transaction, the transacting including:
receiving a transaction request signal from the buyer or the seller;
sending an available key query signal, by the key cycler controller to the database, to identify at least one private key with the status of available;
receiving by the key cycler controller a key availability signal from the database, wherein the key availability signal includes availability by the indices of the private keys;
on condition there are no private keys with the status of available:
waiting until at least one private key has the status of available, on a web based key management service;
using the key cycler and the available more than one private keys to simultaneously process a currency transfer from the buyer for the NFT with a payment processor, and a transfer of ownership, from the seller, of the NFT on the blockchain.

2. The method of claim 1, wherein the digital storefront platform further comprises an anti-money laundering (AML) module, the AML module configured for:
receiving digital on blockchain information and digital off blockchain information, wherein the receiving includes a digital asset intake engine;
extracting digital data from the digital on blockchain information and the digital off blockchain information;
contextualizing relationships based on the digital data and the digital off blockchain information and the digital on blockchain information, the contextualizing including an entity knowledge base;
analyzing the digital data and transforming the digital data to an identified behavior category, thereby creating classified risk data, wherein the analyzing and transforming includes a risk classification engine including a machine learning model;
analyzing the classified risk data and assigning a risk score to each classified risk data, wherein the analyzing and assigning includes a risk scoring regression engine and machine learning;
analyzing the classified risk data and determining if any deviations from rules or standards have or will occur, wherein the analyzing and determining includes a risk policy engine that is a rules based engine; and
taking an action on the digital on blockchain information and digital off blockchain information based on the assigned risk score and any deviations from rules or standards, wherein taking the action includes a security control system, wherein the action includes:
on condition the risk score is high:
at least one of blocking a blockchain transaction, freezing user assets, or suspending user accounts related to the blockchain transaction; and
on condition the risk score is normal:
approving the blockchain transaction.

3. The method of claim 1, further comprising:
receiving, by the trade module, fiat currency from the buyer; and
processing, with the trade module and the more than one private key, the currency transfer from the buyer, using cryptocurrency and the payment processor.

4. The method of claim 1, further comprising:
receiving, by the key cycler controller, the transaction request signal through action of at least one of:
the user minting the at least one new NFT using the mint module;
the user offering the at least one new NFT for purchase using the trade module; and
the buyer purchasing the at least one new NFT using the trade module; and determining, by the key cycler controller, if the transaction proceeds,
on condition the transaction proceeds:
sending a transaction proceeds signal to the mint module or trade module who's user action generated the transaction request signal;
on condition the transaction does not proceed:
sending a transaction termination signal to the mint module or trade module who's user action generated the transaction request signal.

5. The method of claim 1, further comprising:
sending, by the key cycler controller, a signing key signal to the KMS, indicating the index of each of the available more than one private keys based on the key availability signal;
sending, by the KMS to the blockchain, at least one transactional signature signal including private key information needed to sign transactions.

6. The method of claim 1, after transacting, the method further comprising:
receiving, by the key cycler controller, a transaction information signal from at least one of the blockchain and the payment processor, wherein the transaction information signal includes information needed to recognize at least one of the transfer of ownership as complete and the currency transfer as complete;
updating by the key cycler controller, based in part on the transaction information signal, the indices with availability of the plurality of private keys.

7. The method of claim 6, further comprising returning, by the key cycler controller, a transaction details signal to at least one of the mint module and the trade module, wherein the transaction details signal verifies that the transaction is complete.

8. The method of claim 1, wherein the digital storefront platform for the NFTs is provided through a Software Development Kit (SDK).

9. A computing apparatus comprising:
a processor; and
a memory storing instructions that, when executed by the processor, configure the apparatus to:
provide a digital storefront platform for the NFTs, wherein the NFTs include smart contract-based digital assets,
the digital storefront platform includes:
a mint module configured to create and mint NFTs on blockchains;
a trade module configured to transact with the minted NFTs;
a key cycler configured to allow parallel transactions with blockchains, payment processors, the mint module, and the trade module, the key cycler including:
a key cycler controller for executing actions within the key cycler and facilitating the parallel transactions including at least one of blockchains, payment processors, the mint module, and the trade module;
a plurality of private keys on a web-based key management service (KMS);
indices of the plurality of private keys; and
a database include the indices and a status of each private key of the plurality of private keys, wherein the status includes available or unavailable;
receive a request from a user to create and mint at least one new NFT on a blockchain, using the mint module;
create and mint the at least one new NFT;
list for sale, using the trade module, the minted at least one new NFT on the digital storefront platform;
transact between a buyer and a seller, with the minted at least one new NFTs including performing the parallel transaction, the transacting including:
receive a transaction request signal from the buyer or the seller;
send an available key query signal, by the key cycler controller to the database, to identify at least one private key with the status of available;
receive by the key cycler controller a key availability signal from the database, wherein the key availability signal includes availability by the indices of the private keys;
on condition there are no private keys with the status of available:
wait until at least one private key has the status of available, on a web based key management service; and
use the key cycler and the available more than one private keys to simultaneously process a currency transfer from the buyer for the NFT with a payment processor, and a transfer of ownership, from the seller, of the NFT on the blockchain.

10. The computing apparatus of claim 9, wherein the digital storefront platform further comprises an anti-money laundering (AML) module and the instructions further configure the apparatus to:
receive digital on blockchain information and digital off blockchain information, wherein the receiving includes a digital asset intake engine;
extract digital data from the digital on blockchain information and the digital off blockchain information;
contextualizing relationships based on the digital data and the digital off blockchain information and the digital on blockchain information, the contextualizing include an entity knowledge base;
analyze the digital data and transforming the digital data to an identified behavior category, thereby creating classified risk data, wherein the analyzing and transforming includes a risk classification engine including a machine learning model;
analyze the classified risk data and assigning a risk score to each classified risk data, wherein the analyzing and assigning includes a risk scoring regression engine and machine learning;
analyze the classified risk data and determining if any deviations from rules or standards have or will occur, wherein the analyzing and determining includes a risk policy engine that is a rules based engine; and
take an action on the digital on blockchain information and digital off blockchain information based on the assigned risk score and any deviations from rules or standards, wherein taking the action includes a security control system, wherein the action includes:
on condition the risk score is high:
at least one of blocking a blockchain transaction, freeze user assets, or suspending user accounts related to the blockchain transaction; and
on condition the risk score is normal:
approve the blockchain transaction.

11. The computing apparatus of claim 9, wherein the instructions further configure the apparatus to:
receive, by the trade module, fiat currency from the buyer; and
process, with the trade module and the more than one private key, the currency transfer from the buyer, using cryptocurrency and the payment processor.

12. The computing apparatus of claim 9, wherein the instructions further configure the apparatus to:
receive, by the key cycler controller, the transaction request signal through action of at least one of:
the user mint the at least one new NFT using the mint module;
the user offer the at least one new NFT for purchase using the trade module; and
the buyer purchase the at least one new NFT using the trade module; and
determine, by the key cycler controller, if the transaction proceeds, on condition the transaction proceeds:
send a transaction proceeds signal to the mint module or trade module who's user action generated the transaction request signal;
on condition the transaction does not proceed:
send a transaction termination signal to the mint module or trade module who's user action generated the transaction request signal.

13. The computing apparatus of claim 9, wherein the instructions further configure the apparatus to:
send, by the key cycler controller, a signing key signal to the KMS, indicating the index of each of the available more than one private keys based on the key availability signal;
send, by the KMS to the blockchain, at least one transactional signature signal including private key information needed to sign transactions.

14. The computing apparatus of claim 9, wherein the instructions further configure the apparatus to, after transacting:
receive, by the key cycler controller, a transaction information signal from at least one of the blockchain and the payment processor, wherein the transaction information signal includes information needed to recognize at least one of the transfer of ownership as complete and the currency transfer as complete;
update by the key cycler controller, based in part on the transaction information signal, the indices with availability of the plurality of private keys.

15. The computing apparatus of claim 14, wherein the instructions further configure the apparatus to return, by the key cycler controller, a transaction details signal to at least one of the mint module and the trade module, wherein the transaction details signal verifies that the transaction is complete.

16. A non-transitory computer-readable storage medium, the computer-readable storage medium including instructions that when executed by a computer, cause the computer to:
provide a digital storefront platform for the NFTs, wherein the NFTs include smart contract-based digital assets,
the digital storefront platform including:
a mint module configured to create and mint NFTs on blockchains;
a trade module configured to transact with the minted NFTs;
a key cycler configured to allow parallel transactions with blockchains, payment processors, the mint module, and the trade module, the key cycler including:
a key cycler controller for executing actions within the key cycler and facilitating the parallel transactions including at least one of blockchains, payment processors, the mint module, and the trade module;
a plurality of private keys on a web-based key management service (KMS);
indices of the plurality of private keys; and
a database include the indices and a status of each private key of the plurality of private keys, wherein the status includes available or unavailable;
receive a request from a user to create and mint at least one new NFT on a blockchain, using the mint module;
create and mint the at least one new NFT;
list for sale, using the trade module, the minted at least one new NFT on the digital storefront platform;
transact between a buyer and a seller, with the minted at least one new NFTs including performing the parallel transaction, the transacting including:
receive a transaction request signal from the buyer or the seller;
send an available key query signal, by the key cycler controller to the database, to identify at least one private key with the status of available;
receive by the key cycler controller a key availability signal from the database, wherein the key availability signal includes availability by the indices of the private keys;
on condition there are no private keys with the status of available:
wait until at least one private key has the status of available, on a web based key management service; and
use the key cycler and the available more than one private keys to simultaneously process a currency transfer from the buyer for the NFT with a payment processor, and a transfer of ownership, from the seller, of the NFT on the blockchain.

17. The computer-readable storage medium of claim 16, wherein the digital storefront platform further comprises an anti-money laundering (AML) module, the AML module configured for:
receive digital on blockchain information and digital off blockchain information, wherein the receiving includes a digital asset intake engine;
extract digital data from the digital on blockchain information and the digital off blockchain information;
contextualizing relationships based on the digital data and the digital off blockchain information and the digital on blockchain information, the contextualizing include an entity knowledge base;
analyze the digital data and transforming the digital data to an identified behavior category, thereby creating classified risk data, wherein the analyzing and transforming includes a risk classification engine including a machine learning model;
analyze the classified risk data and assigning a risk score to each classified risk data, wherein the analyzing and assigning includes a risk scoring regression engine and machine learning;
analyze the classified risk data and determining if any deviations from rules or standards have or will occur, wherein the analyzing and determining includes a risk policy engine that is a rules based engine; and
take an action on the digital on blockchain information and digital off blockchain information based on the assigned risk score and any deviations from rules or standards, wherein taking the action includes a security control system, wherein the action includes:
on condition the risk score is high:
at least one of blocking a blockchain transaction, freeze user assets, or suspending user accounts related to the blockchain transaction; and
on condition the risk score is normal:
approve the blockchain transaction.

18. The computer-readable storage medium of claim 16, wherein the instructions further configure the computer to:
receive, by the trade module, fiat currency from the buyer; and
process, with the trade module and the more than one private key, the currency transfer from the buyer, using cryptocurrency and the payment processor.

19. The computer-readable storage medium of claim 16, wherein the instructions further configure the computer to:
receive, by the key cycler controller, the transaction request signal through action of at least one of:
the user mint the at least one new NFT using the mint module;
the user offer the at least one new NFT for purchase using the trade module; and
the buyer purchase the at least one new NFT using the trade module; and
determine, by the key cycler controller, if the transaction proceeds,
on condition the transaction proceeds:
send a transaction proceeds signal to the mint module or trade module who's user action generated the transaction request signal;
on condition the transaction does not proceed:
send a transaction termination signal to the mint module or trade module who's user action generated the transaction request signal.

20. The computer-readable storage medium of claim 16, wherein after transacting the instructions further configure the computer to:
receive, by the key cycler controller, a transaction information signal from at least one of the blockchain and the payment processor, wherein the transaction information signal includes information needed to recognize at least one of the transfer of ownership as complete and the currency transfer as complete;
update by the key cycler controller, based in part on the transaction information signal, the indices with availability of the plurality of private keys.
